(19) United States
(12) Patent Application Publication
(10) Pub. No.: US 2007/0199011 A1
(43) Pub. Date: Aug. 23, 2007

(54) System and method for high quality AVC encoding

(75) Inventors: Ximin Zhang, San Jose, CA (US); Takao Yamazaki, Kawasaki (JP)

Correspondence Address: Jonathan O. Owens;HAVERSTOCK & OWENS LLP, 162 North Wolfe Road, Sunnyvale, CA, 94086, US

(73) Assignees: Sony Corporation; Sony Electronics Inc.

(21) Appl. No.: 11/356,832

(22) Filed: Feb. 17, 2006

(51) Int. Cl. H04N 7/16

(52) U.S. Cl. 725/1

(57) ABSTRACT

A video coding system receives as input a video sequence including a series of picture frames. One or more long term references are selected from the input video sequence, at least one of the long term references is a long term look-behind reference frame. Short term reference frames are also selected according to the standards. The frames are then re-ordered for encoding such that the long term look-behind reference is encoded first, followed by the remaining frames according to the conventional order dictated by the standards. Each frame is encoded according to motion estimation and motion compensation, and an intra prediction method that incorporates the use of the long term look-behind reference frame. Further, encoding of each long term look-behind reference frame includes quantization according to a controlled bit-rate. The bit-rate is increased for quantization of each long term look-behind reference frame, thereby increasing its quality. For each other frame, the bit rate is maintained at a normalized level.

### FIELD OF THE INVENTION

The present invention relates to the field of video encoding. More particularly, the present invention relates to the field of high quality AVC encoding by using long term reference pictures enhancement and look behind reference pictures selection.

### BACKGROUND OF THE INVENTION

A video sequence consists of a number of pictures, usually called frames. Subsequent frames are very similar, thus containing a lot of redundancy from one frame to the next. Before being efficiently transmitted over a channel or stored in memory, video data is compressed to conserve both bandwidth and memory. The goal is to remove the redundancy to gain better compression ratios. A first video compression approach is to subtract a reference frame from a given frame to generate a relative difference. A compressed frame contains less information than the reference frame. The relative difference can be encoded at a lower bit-rate with the same quality. The decoder reconstructs the original frame by adding the relative difference to the reference frame.

A more sophisticated approach is to approximate the motion of the whole scene and the objects of a video sequence. The motion is described by parameters that are encoded in the bit-stream. Pixels of the predicted frame are approximated by appropriately translated pixels of the reference frame. This approach provides an improved predictive ability than a simple subtraction. However, the bit-rate occupied by the parameters of the motion model must not become too large.

In general, video compression is performed according to many standards, including one or more standards for audio and video compression from the Moving Picture Experts Group (MPEG), such as MPEG-1, MPEG-2, and MPEG-4. Additional enhancements have been made as part of the MPEG-4 part 10 standard, also referred to as H.264, or AVC (Advanced Video Coding). Under the MPEG standards, video data is first encoded (e.g. compressed) and then stored in an encoder buffer on an encoder side of a video system. Later, the encoded data is transmitted to a decoder side of the video system, where it is stored in a decoder buffer, before being decoded so that the corresponding pictures can be viewed.

MPEG is used for the generic coding of moving pictures and associated audio and creates a compressed video bit-stream made up of a series of three types of encoded data frames. The three types of data frames are an intra frame (called an I-frame or I-picture), a bi-directional predicated frame (called a B-frame or B-picture), and a forward predicted frame (called a P-frame or P-picture). These three types of frames can be arranged in a specified order called the GOP (Group Of Pictures) structure. I-frames contain all the information needed to reconstruct a picture. The I-frame is encoded as a normal image without motion compensation. On the other hand, P-frames use information from previous frames and B-frames use information from previous frames, a subsequent frame, or both to reconstruct a picture. Specifically, P-frames are predicted from a preceding I-frame or the immediately preceding P-frame.

Frames can also be predicted from the immediate subsequent frame. In order for the subsequent frame to be utilized in this way, the subsequent frame must be encoded before the predicted frame. Thus, the encoding order does not necessarily match the real frame order. Such frames are usually predicted from two directions, for example from the I- or P-frames that immediately precede or the P-frame that immediately follows the predicted frame. These bidirectionally predicted frames are called B-frames. There are many possible GOP structures. A common GOP structure is 15 frames long, and has the sequence I_BB_P_BB_P_BB_P_BB_P_BB_A similar 12-frame sequence is also common. I-frames encode for spatial redundancy, P and B-frames for temporal redundancy.

Because adjacent frames in a video stream are often well-correlated, P-frames and B-frames are only a small percentage of the size of I-frames. However, there is a trade-off between the size to which a frame can be compressed versus the processing time and resources required to encode such a compressed frame. The ratio of I, P and B-frames in the GOP structure is determined by the nature of the video stream and the bandwidth constraints on the output stream, although encoding time may also be an issue. This is particularly true in live transmission and in real-time environments with limited computing resources, as a stream containing many B-frames can take much longer to encode than an I-frame-only file.

B-frames and P-frames require fewer bits to store picture data, generally containing difference bits for the difference between the current frame and a previous frame, subsequent frame, or both. B-frames and P-frames are thus used to reduce redundancy information contained across frames. In operation, a decoder receives an encoded B-frame or encoded P-frame and uses a previous or subsequent frame to reconstruct the original frame. This process is much easier and produces smoother scene transitions when sequential frames are substantially similar, since the difference in the frames is small.

Each video image is separated into one luminance (Y) and two chrominance channels (also called color difference signals Cb and Cr). Blocks of the luminance and chrominance arrays are organized into “macroblocks,” which are the basic unit of coding within a frame.

In the case of I-frames, the actual image data is passed through an encoding process. However, P-frames and B-frames are first subjected to a process of “motion compensation.” Motion compensation is a way of describing the difference between consecutive frames in terms of where each macroblock of the former frame has moved. Such a technique is often employed to reduce temporal redundancy of a video sequence for video compression. Each macroblock in the P-frames or B-frame is associated with an area in the previous or next image that it is well-correlated, as selected by the encoder using a “motion vector.” The motion vector that maps the macroblock to its correlated area is encoded, and then the difference between the two areas is passed through the encoding process.

Conventional video codecs use motion compensated prediction to efficiently encode a raw input video stream. The macroblock in the current frame is predicted from a displaced macroblock in the previous frame. The difference between the original macroblock and its prediction is compressed and transmitted along with the displacement (motion) vectors. This technique is referred to as inter-coding, which is the approach used in the MPEG standards.

The output bit-rate of an MPEG encoder can be constant or variable, with the maximum bit-rate determined by the playback media. To achieve a constant bit-rate, the degree of quantization is iteratively altered to achieve the output bit-rate requirement. Increasing quantization leads to visible artifacts when the stream is decoded. The discontinuities at the edges of macroblocks become more visible as the bit-rate is reduced.

When the bit rate is fixed, the effective bit allocation can obtain better visual quality in video encoding. Conventionally, each frame is divided into foreground and background. More bits are typically allocated to the foreground objects and fewer bit are allocated to the background area based on the reasoning that viewers focus more on the foreground than the background. Such reasoning is based on the assumption that the viewer may not see the difference in the background if they do not focus on it. However, this is not always the case. Moreover, due to the characteristics of the H.264 standard, less bits in the background often leads to blurring, and the intra refresh phenomenon is very obvious when the background quality is low. The refresh in the static area, usually the background, annoys the human eye significantly and thus influences the visual quality.

To improve the quality of the background, a simple method allocates more bits to the background. This strategy will reduce the bits allocated to the foreground area, which is not an acceptable trade-off. Also, to make the fine details observable, the quantization scale needs to be reduced considerably, which means the bit-rate budget will be exceeded.

Another disadvantage is that the assumption of repetition of image sequence content is not true for most of the sequence. In most cases, the motion is mostly going along in one direction within several seconds. There is a limited match in previous frames for uncovered objects in the current frame. Unfortunately, state of the art long term motion prediction methods focus on the earlier frames as the reference.

An objective of the H.264 standard is to enable quality video at bit-rates that are substantially lower than what the previous standards would need. An additional objective is to provide this functionality in a flexible manner that allows the standard to be applied to a very wide variety of applications and to work well on a wide variety of networks and systems. Unfortunately, conventional encoders employing the MPEG standards tend to blur the fine texture details even in a relative high bit-rate. Also, the I-frame refresh is very obvious when the low bit-rate is used. As such, whenever an I-frame is displayed, the quality is much greater than the previous, non I-frames, which produces a discontinuity whenever the I-frame is displayed. Such a discontinuity is noticeable to the user. Although the MPEG video coding standard specifies a general coding methodology and syntax for the creation of a legitimate MPEG bit-stream, there are many opportunities left open to improve the quality of MPEG bit-streams.

### SUMMARY OF THE INVENTION

A coding system utilizes a moderate bit-rate to address the aforementioned problems related to low bit-rate and high bit-rate. Further, it is observed that the initial reference quality influences the subsequent prediction quality significantly. Considering the good motion estimation capability of AVC, if very good visual fidelity is kept in the I-frame, it is possible to propagate the good quality to the subsequent P-frames and B-frames. Instead of using more bits on the foreground objects and fewer bits on the background area, as in the prior art, the coding system significantly improves the visual quality of the background using a long term look-behind prediction. In contrast to using previous frames as the reference predictor for a current frame, an accurate prediction is obtained by using a long term look-behind reference frame that follows the current frame.

In conventional bit-rate control schemes, a fixed bit-rate ratio is maintained between the I-frame and the P-frame. In contrast, embodiments of the coding system are configured to reduce the quantization scale of the I-frame, thereby improving the visual quality of the P-frames and B-frames, while maintaining the same bit-rate. In this manner, more details are shown in the P-frames and B-frames and the I-frame refresh phenomenon is reduced.

Embodiments of the coding system also utilize the long term look-behind reference frame as a long term memory motion compensation prediction scheme to effectively handle uncovered areas, also called uncovered objects, in the background. Use of such a prediction scheme compensates for blurring of uncovered objects in the P-frames and B-frames between I-frames. Long term memory motion compensated prediction extends the spatial displacement vector (MV) utilized in macroblock-based hybrid video coding by a variable time delay, thereby permitting the use of more frames than the previously decoded frame for motion compensation. Improvements are expected due to repetition of image sequence content such as covered and uncovered objects, shaking of camera back and forth, etc. Additionally, improvements are obtained when macroblocks in long term memory are coincidentally similar to the current macroblock.

In most cases, for a given video sequence, an uncovered object in the current frame also appears in subsequent frames. Typically, the uncovered object is observed in subsequent frames for a given time period, such as ½ second, before it is covered again or moved out of frame. As such, most uncovered objects can be matched to known areas in subsequent frames. Utilization of the B-frame improves performance because the B-frame uses information from the subsequent P-frame to reconstruct a picture. The issue is how to construct the P-frame since the P-frame is predicted from earlier frames, not a subsequent frame. If there is not a good prediction for the P-frame, then a good prediction match for the B-frame can not be obtained. The coding system uses the long term look-behind reference frame as a predictive reference that can be used to construct the P-frame.

In one aspect, a method of encoding data including a plurality of successive frames is described. The method includes receiving a plurality of input frames, buffering a number of the plurality of input frames, selecting one or more long term reference frames from the number of frames, wherein at least one of the one or more long term reference frames comprises a long term look-behind reference frame, encoding the one or more long term reference frames, wherein encoding the at least one long term look-behind reference frame includes quantizing at an increased bit rate, updating a prediction scheme according to the at least one long term look-behind reference frame, and encoding a remainder of the number of frames according to the updated prediction scheme. The method can also include generating a quality index used to determine the increased bit rate. The method can also include updating the quality index each encoding cycle based on a comparison between the long term look-behind reference frame a reconstructed frame of the encoded long term look-behind reference frame. The method can also include further comprising managing a reference frame buffer to include a most current short term reference frames and a most current one or more long term reference frames. The method can also include encoding the short term reference frames and the remainder of the number of frames that are not short term reference frames according to an encoding scheme dictated by the standards. Updating the prediction scheme can include updating the reference frame buffer. Encoding the remainder of the number of frames can include quantizing at a normal bit rate. Encoding the one or more long term reference frames occurs in chronological order. The method can also include re-ordering the number of frames into an encoding frame sequence such that the one or more long term references are placed first in the encoding frame sequence. The prediction scheme can include correlation characteristics between the one or more long term reference frames and the number of frames. The method can also include determining the correlation characteristics by calculating a simple frame difference. The method can also include determining the correlation characteristics by utilizing a scene change detection method. The data can be encoded according to an MPEG standard. The at least one long term look-behind reference frame can be an I-frame. The method can also include selecting a next long term look-behind reference frame as a next I-frame in the plurality of input frames.

In another aspect, a method of encoding data includes receiving a plurality of input frames, buffering a number of the plurality of input frames, wherein the number of frames includes at least a first I-frame, a second I-frame chronologically later than the first I-frame, and all frames therebetween, selecting one or more long term reference frames from the number of frames, wherein at least one of the one or more long term reference frames comprises the second I-frame, encoding the second I-frame, updating a prediction scheme according to the encoded second I-frame, and encoding a remainder of the number of frames according to the updated prediction scheme. The second I-frame can include a long term look-behind reference frame. Encoding the second I-frame can include quantizing at an increased bit rate. Encoding the remainder of the number of frames can include quantizing at a normal bit rate, further wherein the increased bit rate is higher than the normal bit rate. The method can also include generating a quality index used to determine the increased bit rate. The method can also include updating the quality index each encoding cycle based on a comparison between the second I-frame and a reconstructed frame of the encoded second I-frame. The method can also include encoding the first I-frame and encoding the prediction scheme according to the encoded first I-frame prior to encoding the remainder of the number of frames. The first I-frame can include a long term look-front reference frame. The method can also include managing a reference frame buffer to include a most current short term reference frames and a most current one or more long term reference frames. The method can also include encoding the short term reference frames and the remainder of the number of frames that are not short term reference frames according to an encoding scheme dictated by the standards. Updating the prediction scheme can include updating the reference frame buffer. Encoding the one or more long term reference frames occurs in chronological order. The method can also include re-ordering the number of frames into an encoding frame sequence such that the one or more long term references are placed first in the encoding frame sequence. The prediction scheme can include correlation characteristics between the one or more long term reference frames and the number of frames. The method can also include determining the correlation characteristics by calculating a simple frame difference. The method can also include determining the correlation characteristics by utilizing a scene change detection method. The method can also include selecting a next long term look-behind reference frame as a next I-frame in the plurality of input frames. The data can be encoded to substantially comply with a MPEG standard.

In yet another aspect, a system to encode data includes an input buffer to receive a plurality of input frames and to buffer a number of the plurality of input frames, a reference frame selection module coupled to the input buffer to select one or more long term reference frames from the number of frames, wherein one of the one or more long term reference frames comprises a long term look-behind reference frame, a frame re-ordering module to sort the number of frames into an encoding frame sequence such that the one or more long term reference frames are first in the encoding frame sequence, and an encoder to encode the number of frames according to the encoding frame sequence, wherein encoding the one or more long term look-behind reference frames includes quantizing at a first bit rate, and encoding a remaining portion of the number of frames includes using a prediction scheme formulated according to the encoded one or more long term look-behind reference frames and quantizing at a second bit rate, the first bit rate higher than the second bit rate. The system can also include a reference frame buffer to store a most current short term reference frames and a most current one or more long term reference frames. The system can also include a reference frame buffer management module to mange and update the reference frame buffer. The system can also include a quality index generator to generate a quality index used to regulate the first bit rate. The system can also include a quality index adaptor to compare a quality of a long term look-behind reference frame to an encoded long term look-behind reference frame to improve a corresponding quality index. The data can be encoded to substantially comply with a MPEG standard. The at least one long term look-behind reference frame can include an I-frame. The number of frames can include at least a first I-frame, a second I-frame chronologically later than the first I-frame, and all frames therebetween.

### BRIEF DESCRIPTION OF THE DRAWINGS

FIG. 1 illustrates an embodiment of an exemplary functional block diagram of a video coding system.

FIG. 2 illustrates an exemplary method performed by the look-behind reference selection module from FIG. 1 to select the one or more lang term references.

FIG. 3 illustrates an exemplary IPPPP GOP structure and an embodiment of the inter frame predictive relationships according to the low complexity mode.

FIG. 4 illustrates an exemplary IBBPBBPBB GOP structure and an embodiment of the inter frame predictive relationships according to the low complexity mode.

Embodiments of the coding system are described relative to the several views of the drawings. Where appropriate and only where identical elements are disclosed and shown in more than one drawing, the same reference numeral will be used to represent such identical elements.

### DETAILED DESCRIPTION OF THE EMBODIMENTS

Embodiments of a video coding system are directed to a bit-rate control module to provide frame enhancement and a long term look-behind reference frame module to provide an improved predictive scheme. Intra frame enhancement benefits the visual quality for the macroblocks that find a good match in the I-frame. Separately, look-behind prediction is utilized to find accurate prediction for uncovered objects if the look-behind reference frame has high quality. The video coding system combines these two qualities, thereby providing a coding scheme for encoding a video sequence.

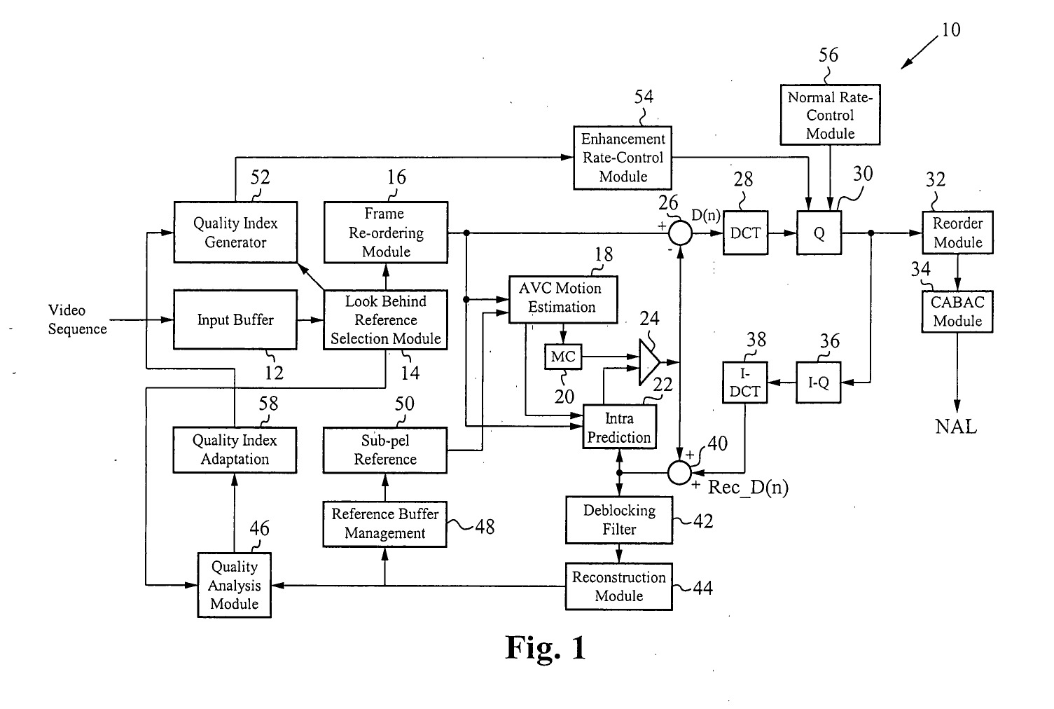

FIG. 1 illustrates an embodiment of an exemplary functional block diagram of a video coding system 10. A video sequence is first input into an input buffer 12. The video sequence includes a series of frames, or pictures. When the video sequence is formatted according to the MPEG standard, each frame is configured as either an I-frame, a P-frame, or a B-frame. Alternatively, the video sequence can be formatted according to another video coding standard.

The series of frames forms a GOP structure according to any number of configurations. As an example and for purposes of discussion, the GOP structure includes 15 frames. In one embodiment, the GOP structure is configured as IPPPPPPPPPPPPPP. In another embodiment, the GOP structure is configured as IBBPBBPBBPBBPBB. It is understood that the GOP structure can be configured according to other sequences and include any number of frames. The input buffer 12 is configured to buffer one GOP and the first frame of the next GOP. In the case where the GOP structure includes 15 frames, the input buffer 12 is configured to buffer 16 frames, including the 15 frames of the current GOP and the first frame of the next GOP. In this manner, two I-frames are stored in the input buffer 12, the I-frame from the current GOP and the I-frame from the next GOP. In alternative embodiments, the input buffer 12 can be configured to store any number of frames.

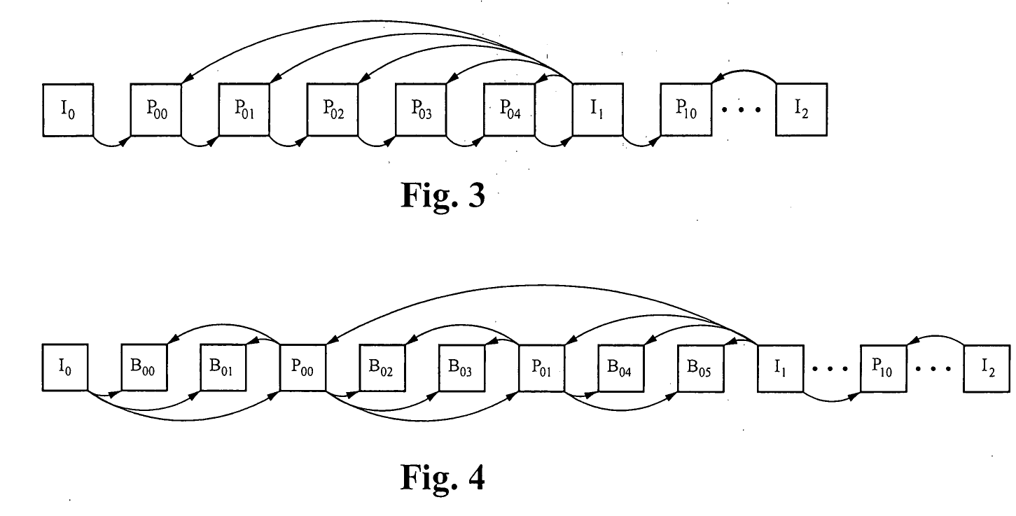

The buffered frames within the input buffer 12 are sent to a look-behind reference selection module 14. In the look-behind reference selection module 14, one or more look-behind long term reference frames are determined. The video coding system is configured to enhance the quality of any long term reference frames. A long term reference frame is any I-frame. An I-frame is either a long term look-behind reference frame, such as I1 in FIGS. 3 and 4, or a long term look-front reference frame, such as I0 in FIGS. 3 and 4. These designations are relative, as for the next GOP, the I1 frame is the long term look-front reference frame. The quality index generator 52 analyzes the long term reference frames received from the look-behind reference selection module 14 to generate a quality index associated with each long term reference frame analyzed. The quality index represents a level of quantization used by a quantization module 30. In order to satisfy some rate constraint, a specific quantization level is required. The quality index represents the specific quantization level.

The quality index is sent to the enhancement rate-control module 54 to modulate the quantization scale used by the quantization module 30. The quantization scale is modulated by the enhancement rate-control module 54 only when the current frame being encoded is a long term reference frame. Otherwise, a normal rate control module 56 modulates the quantization scale according to a standard rate such that the bit-rate budget is satisfied.

Once the look-behind long term reference frames are selected, the series of frames buffered in the input buffer 12 are re-ordered in the frame reordering module 16. The frames are re-ordered according to the following priority: first, the long term reference frames (among them, using natural order); second, the remaining frames according to the conventional order dictated by the standards. For example, the frames shown in FIG. 3 are reordered according to I0, I1, P00, P01, P02, P03 and so on. The frames shown in FIG. 4 are reordered according to I0, I1, P00, B00, B01, P01, B02, B03, and so on. The reordered frames are then sent to a conventional AVC encoder. An exemplary AVC encoder includes an AVC motion estimation module 18, a motion compensation module 20, an intra prediction module 22, a comparator 24, a summing circuit 26, a discrete cosine transform (DCT) module 28, a quantization (Q) module 30, a reorder module 32 a CABAC module 34, an inverse quantization (IQ) module 36, an inverse DCT (IDCT) module 38, a summing circuit 40, a deblocking filter 42, and a reconstruction module 44.

Within the AVC encoder, the reordered frames are sent to the AVC motion estimation module 18 and then to the motion compensation module 20. The intra prediction module 22 also receives the reordered frames from the frame reordering module 16 and the output from the AVC motion estimation module 18. The comparator 24 compares the motion compensated result from the motion compensation module 20 and the intra prediction from the intra prediction module 22 to select the input with the least cost option that represents the current frame. The output from the comparator 24 is the prediction result. The summing circuit 26 takes the difference between the reordered sequence of frames output from the frame reordering module 16 and the predicted results output from the comparator 24 to generate a residual result D(n). A discrete cosine transform and quantization are performed on the residual result D(n) by the DCT module 28 and the Q module 30, respectively.

Output from the Q module 30 is sent to the reorder module 32, where macroblocks are encoded. The CABAC module 34 performs arithmetic coding and outputs an NAL bit stream.

The output from the Q module 30 is also sent to the IQ module 36, where inverse quantization is performed. The output from the IQ module 36 is sent to the IDCT module 38, where inverse discrete cosine transform is performed. The summing circuit 40 adds the output from the IDCT module 38 and the predicted results from the comparator 24 to output a reconstructed result. The reconstructed result is input to the deblocking filter 42 and to the intra prediction module 22. Within the deblocking filter 42, the reconstructed result is partitioned into blocks. The deblocking filter 42 is used to reduce the appearance of block-like artifacts. The reconstruction module 44 reconstructs the blocks output from the deblocking filter 42 into a reconstructed frame. The reconstructed frame is sent to the reference buffer management module 48 and to the quality analysis module 46.

The reference buffer management module 48 determines which reconstructed frames are long term reference frames and which are short term reference frames. The reference buffer management module 48 also manages a long term reference buffer and a short term reference buffer, which is described in greater detail below.

The reconstructed frames are sent from the reference buffer management module 48 to the sub pel reference module 50, where a half pel interpolated frame and a quad pel interpolated frame are generated. The half pel frame and the quad pel frame are output to the AVC motion estimation module 18.

The quality index used to enhance the quality of the long term reference frames is adapted according to the reconstructed frame output from the reconstruction module 44. The reconstructed frame is analyzed by the quality analysis module 46. As part of the analysis, the quality of the reconstructed frame is measured against the original frame to determine if the quality index provides sufficient quality. If the analysis determines that the quality is insufficient, then the quality index adaptation module 58 generates an adapted quality index, which is sent to the quality index generator 52. The analysis performed by the quality analysis module 46 is used by the quality index adaptation module 58 to adjust the quality index. The quality index is analyzed and adapted, if necessary, at the end of each encoding cycle.

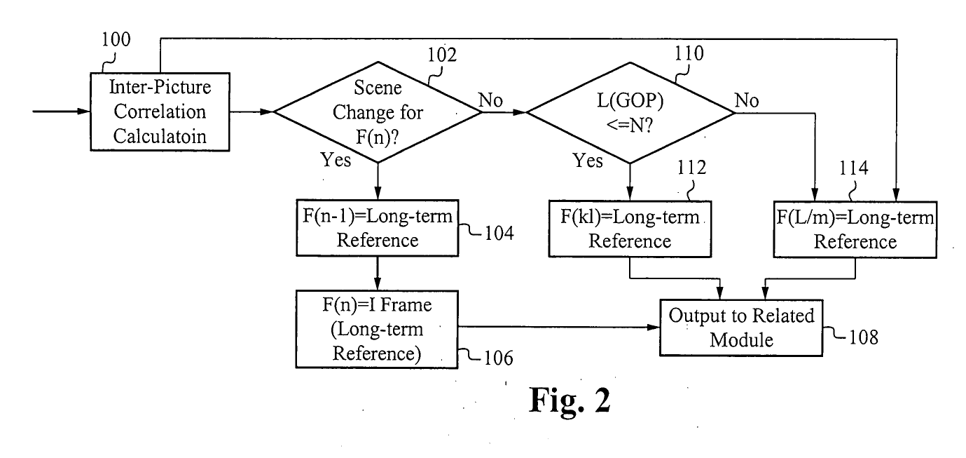

FIG. 2 illustrates an exemplary method performed by the look-behind reference selection module 14 from FIG. 1 to select the one or more long term references. At the step 100, an inter-correlation between consecutive frames received by the look-behind reference selection module 14 is calculated. At the step 102, it is determined if a scene change occurs from a previous frame, F(n-1), to a current frame, F(n), before the next I-frame in the video sequence. If it is determined in the step 102 that a scene change does occur, then at the step 104 the previous frame F(n-1) is labeled as a long term look-behind reference frame, and at the step 106 the current frame F(n) is set as an I-frame for the start of a new GOP.

If no scene change is detected at the step 102, then at the step 110 it is determined if the GOP size, L(GOP), is less than or equal to a predefined threshold N. If it is determined that the GOP size L(GOP) is less than or equal to N, then at the step 112 each I-frame is labeled as a long term look-behind reference frame. In FIG. 2, kL means the integer number of GOP size L. The threshold N can be obtained by collecting statistics from many video sequences. In one embodiment, N=15. Alternatively, N can be any number. If it determined at the step 110 that the GOP size L(GOP) is greater than N, then at the step 114 the GOP is divided into m intervals, each interval with length L/m. The designation m is an integer and its value is determined by the correlation between the frames. If the correlation between the frames is strong, then m=1. If high motion activity is demonstrated, then m=2 or 3. A selected long-term reference frame that is not an I-frame is encoded as a P-frame. After either the step 106, the step 112, or the step 114, the current frame is output to the quality index generator 52 and to the frame reordering module 16 at the step 108.

According to the AVC standard, backward (look-behind) prediction is only supported by B-frames. Additionally, owing to the adoption of a long-term reference frame in the AVC standard, individual frames can be placed in arbitrary positions within the long-term reference buffer. As such, the video coding system 10 reorders frames stored in the long term reference buffer to utilize the selected long term look-behind reference frames as predictors for subsequently encoded P-frames and B-frames.

As previously described, the video coding system 10 is configured to select one or more long term reference frames. In a low complexity mode, one long term reference frame is selected. In this case, the long term reference frame is the long term look-behind reference frame. FIG. 3 illustrates an exemplary IPPPP GOP structure and an embodiment of the inter frame predictive relationships according to the low complexity mode. FIG. 4 illustrates an exemplary IBBPBBPBB GOP structure and an embodiment of the inter frame predictive relationships according to the low complexity mode.

In a high quality mode, multiple long term reference frames are selected. In this case, one of the long term reference frames is the long term look-behind reference frame. The high quality mode can be applied to both the IP only GOP structure and the IBBP GOP structures discussed above.

When one long term reference frame is used, as in the low complexity mode, the long term reference is the long term look-behind reference frame, such as 11 in FIGS. 3 and 4. When multiple long term reference frames are used, as in the high quality mode, the long term reference frames are long term look-front reference frames, such as I0 in FIGS. 3 and 4, the long term look-behind reference frame, such as I1, and possibly the next P-frame in the encoding sequence. The next P-frame is used as a long term reference frame when the size of the GOP, L(GOP), is greater than the threshold N, as described above in relation to FIG. 2.

In the AVC standard, a B-frame is predicted from the immediately preceding I-frame or P-frame and the next P-frame or I-frame. For example, in reference to the video sequence in FIG. 4, the B-frame B00 is predicted from the immediately preceding I-frame I0 and from the next P-frame P00, according to the AVC standard. Also according to the AVC standard, a P-frame is predicted from the immediately preceding I-frame or P-frame. For example, the P-frame P00 is predicted from the immediately preceding I-frame I0, according to the AVC standard. There is neither backward prediction for the I-frame nor long term backward prediction for either the B-frame or the P-frame, according to the AVC standard recommended implementation. Within this implementation, application of the long term reference has been limited to long term look-front reference frame, as in the I-frame I0 being used as a forward predictor for the frames B00, B01, and P00. Embodiments of the video coding system expand the conventional definition of the long term reference frame to include a long term look-behind reference frame which is used as a backward predictor, such as the I-frame I1 being used to predict the preceding P-frames in FIG. 3 and the preceding P-frames and B-frames in FIG. 4. Using the long term look-behind reference frame, each P-frame is predicted from the immediately preceding I-frame, such as I0, and from the long term look-behind reference frame, such as I1.

In the low complexity mode, the first I-frame subsequent to a current frame is selected as a long term look-behind reference frame. As applied to the GOP structure in FIG. 3, the first selected long term look-behind reference frame is I1. Table 1 illustrates management of a reference frame buffer corresponding to the GOP structure and inter frame relationships of FIG. 3.

TABLE 1

| | Reference Frame | Reference Frame |
|---|---|---|
| Operation | Short Term | Long Term |
| Initial state | | |
| Encode I0 | I0 | |
| Encode I1 | I0 | I1 |
| Encode P00 | P00 | I1 |
| Encode P01 | P01 | I1 |
| Encode P02 | P02 | I1 |
| Encode P03 | P03 | I1 |
| Encode P04 | P04 | I1 |
| Encode I2 | I1 | I2 |
| Encode P10 | P10 | I2 |

The reference buffer is divided into a short term buffer and a long term buffer. In the low complexity mode, a current frame is predicted using a short term reference frame and long term reference frame. With an IP GOP structure, the current frame is either an I-frame or a P-frame. An I-frame does not utilize a prediction scheme. A P-frame is predicted according to the previous frame and the long term reference frame. The long term buffer stores the long term look-behind reference frame. The short term buffer stores the encoded previous frame, unless the previous frame was the most recent long term look-behind reference frame. Before the completion of one encoding cycle, only the short-term buffer is updated. The long-term buffer is updated once the next long-term look-behind reference frame is encoded. Referring to FIG. 3 and Table 1, I0 is encoded and placed in the short term buffer. I1 is encoded, and since I1 is the most recent long term look-ahead reference frame, it is placed in the long term buffer. When the current frame to be encoded is P00, the frame P00 is predicted according to the reference frames already stored in the short and long term buffers, which in this case are the frames I0 and I1, respectively. Once the frame P00 is encoded, the frame P00 is placed in the short term buffer. This process continues for each frame P01, P02, P03, and P04. After I2 is encoded, I1 is no longer the most recent long term look-ahead reference frame, but it is the previous frame in the sequence, relative to P10, so I1 is placed in the short term buffer, and I2 is placed in the long term buffer.

Table 2 illustrates management in a low complexity mode of a reference frame buffer corresponding to the IBBP GOP structure and inter frame relationships of FIG. 4.

TABLE 2

| | |
|---|---|
| Reference Frame | Reference Frame |
| List 1 | List 2 |

| | Short Term | Long Term | Short Term |
|---|---|---|---|
| Operation | Buffer | Buffer | Buffer |
| Initial State | | | |
| Encode I0 | I0 | | |
| Encode I1 | I0 | I1 | |
| Encode P00 | I0 | I1 | P00 |
| Encode B00 | I0 | I1 | P00 |
| Encode B01 | I0 | I1 | P00 |
| Encode P01 | P00 | I1 | P01 |
| Encode B02 | P00 | I1 | P01 |
| Encode B03 | P00 | I1 | P01 |
| Encode B04 | P01 | I1 | I1 |
| Encode B05 | P01 | I1 | I1 |
| Encode I2 | I1 | I2 | I1 |
| Encode P10 | I1 | I2 | P10 |

Since B-frames are additionally predicted from the next P-frame when compared to the prediction used for a P-frame, an additional reference buffer is need to store the next P-frame used for B-frame prediction. As such, Table 2 includes a forward reference frame buffer (reference frame list 1) and a backward reference frame buffer (reference frame list 2). In the low complexity mode, one long term reference frame is used. In one embodiment, the reference frame list 1 includes a short term buffer and a long term buffer, and the reference frame list 2 includes a short term buffer, as shown in Table 2. In this embodiment, it is assumed that a high quality can be propagated from the P-frame to the B-frame. In alternative embodiments, the long term look-behind reference frame can also be used directly for B-frame prediction.

As shown in Table 2 and FIG. 4, each P-frame is predicted from the immediately preceding I-frame or P-frame and the long term look-behind reference frame. For example, the frame P00 is predicted from the immediately preceding I-frame I0 stored in the first short term buffer and the frame P00 is also predicted from the long term look-behind reference frame I1 stored in the long term buffer. Similarly, the frame P01 is predicted from the immediately preceding P-frame P00 stored in the second short term buffer (reference frame list 2 in Table 2) and from the long term look-behind reference frame I1 stored in the long term buffer. As also shown in Table 2 and FIG. 4, each B-frame is predicted from the immediately preceding I-frame or P-frame and the next I-frame or P-frame. For example, the frames B00 and B01 are each predicted from the immediately preceding I-frame I0 stored in the first short term buffer and predicted from the next P-frame P00 stored in the second short term buffer. Similarly, the frames B02 and B03 are each predicted from the immediately preceding P-frame P00 stored in the first short term buffer and predicted from the next P-frame P01 stored in the second short term buffer.

In the high quality mode, multiple long term references are used. When two long-term reference frames are used, the long term buffer is divided to store both a long term look-behind reference frame and long term look-front reference frame. In one embodiment of the high quality mode applied to the IBBP GOP structure, the long term look-behind reference frame is added into the second reference frame buffer. Then, if the current frame being encoded is a B-frame, the long-term look-behind reference frame is only used in the backward prediction. For the long-term look-front reference frame, the previous reconstructed I-frame is set as the first priority, the other long term reference frames can be selected based on any scheme. In the long-term reference buffer, the long term look-behind reference frame is given higher priority than the long term look-front reference frame if they are located within the same encoding cycle. For example, if three long-term reference frames are used, one long term look-front reference frame and two long term look-behind reference frames are selected.

Table 3 illustrates management in a high quality mode of a reference frame buffer corresponding to an IP only GOP structure.

TABLE 3

| | Reference Frame | Reference Frame | Reference Frame |
|---|---|---|---|
| Operation | Short Term | Long Term 1 | Long Term 2 |
| Initial state | | | |
| Encode I0 | I0 | | |
| Encode I1 | I0 | I0 | I1 |
| Encode P00 | P00 | I0 | I1 |
| Encode P01 | P01 | I0 | I1 |
| Encode P02 | P02 | I0 | I1 |
| Encode P03 | P03 | I0 | I1 |
| Encode P04 | P04 | I0 | I1 |
| Encode I2 | I1 | I0 | I2 |
| Encode P10 | P10 | I1 | I2 |
| . | | | |
| . | | | |
| . | | | |

Table 3 shows management of the reference buffer in a manner similar to the low complexity mode demonstrated in reference to Table 1 but with the addition of a second long term buffer. In this manner, a long term look-behind reference frame is stored in the second long term buffer and a long term look-front reference buffer is stored in the first long term buffer. Each P-frame is predicted according to the previous frame and the two long term reference frames. For example, P-frame P00 is predicted from the frames I0 and I1, where the frame I0 is both the previous frame and the long term look-front reference frame. Similarly, P-frame P01 is predicted from the previous frame P00, the long term look-front reference frame I0, and the long term look-behind reference frame I1.

Table 4 illustrates management in a high quality mode of a reference frame buffer corresponding to an IBBP GOP structure.

TABLE 4

| | |
|---|---|
| Reference Frame | Reference Frame |
| List 1 | list 2 |

| Operation | 0 | 1 | 2 | 0 | 1 |
|---|---|---|---|---|---|
| Initial State | I0 | | | | |
| Encode I0 | I0 | | | | |
| Encode I1 | I0 | I1 | | | I1 |
| Encode P00 | I0 | I1 | | P00 | I1 |
| Encode B00 | I0 | I1 | | P00 | I1 |
| Encode B01 | I0 | I1 | | P00 | I1 |
| Encode P01 | P00 | I0 | I1 | P01 | I1 |
| Encode B02 | P00 | I0 | I1 | P01 | I1 |
| Encode B03 | P00 | I0 | I1 | P01 | I1 |
| Encode I2 | P01 | I0 | I1 | I1 | I2 |
| Encode B04 | P01 | I0 | I1 | I1 | I2 |
| Encode B05 | P01 | I0 | I1 | I1 | I2 |
| Encode P10 | I1 | I0 | I2 | P10 | I2 |

The buffer management process shown in Table 4 is similar to the low complexity mode demonstrated in reference to Table 2 but with a second long-term reference frame in reference frame list 1 and one long-term reference frame in reference frame list 2. Referring to Table 1, the designation 0, 1, and 2 in the reference frame list 1 refer to short term reference frame buffer, long term look-front reference frame buffer, and long term look-behind reference frame buffer, respectively. The designations 0 and 1 in the reference frame list 2 refer to short term reference frame buffer and long term look-behind reference buffer, respectively. Each P-frame is predicted according to the previous I-frame or P-frame and the two long term reference frames. For example, P-frame P01 is predicted from the previous frame P00, the long term look-front reference frame I0, and the long term look-behind reference frame I1. Each B-frame is predicted from the immediately preceding I-frame or P-frame, the next I-frame or P-frame, and the long term look-behind reference frame. For example, the frames B00 and B01 are each predicted from the immediately preceding I-frame I0 stored in the first short term buffer, the next P-frame P00 stored in the second short term buffer, and the long term look-behind reference frame I1 stored in the long term buffer of reference frame list 2. Similarly, the frames B02 and B03 are each predicted from the immediately preceding P-frame P00 stored in the first short term buffer, the next P-frame P01 stored in the second short term buffer, and the long term look-behind reference frame I1 stored in the long term buffer of reference frame list 2.

The configuration of the reference buffers shown and described in relation to Tables 1-4 are for exemplary purposes only. It is understood that the video coding system can be configured to buffer one or more long term references in a manner different than that described in relation to Tables 1-4.

In operation, the video coding system receives as input a video sequence including a series of picture frames. One or more long term references are selected from the input video sequence, at least one of the long term references is a long term look-behind reference frame. In one embodiment, each I-frame in the video sequence is always a long term look-behind reference frame. Short term reference frames are also selected according to the standards. Once the long term look-behind reference frame is selected, the frames are re-ordered for encoding such that the long term look-behind reference is encoded first, followed by the remaining frames according to the conventional order dictated by the standards. Each frame is encoded according to motion estimation and motion compensation as is well known in the art. In addition, encoding is performed using an intra prediction method that incorporates the use of a long term look-behind reference frame. Further, encoding of each long term look-behind reference frame includes quantization according to a controlled bit-rate. The bit-rate is increased for quantization of each long term look-behind reference frame, thereby increasing its quality. For each other frame, the bit rate is maintained at a normalized level. After the encoding, if the encoded frame is to be used as a short term or long term reference frame, a reconstructed frame representative of the encoded frame is sent to the reference buffer management module to update the contents in the reference buffer. If the reconstructed frame is the last frame before the look behind long term reference frame in the natural display order, then this signals the end of one encoding cycle. Based on the encoding results of this cycle, the quality index is adjusted for the encoding of the next look behind long term reference frames. The above process is repeated until the end of the video sequence. The last frame is always labeled as the look behind long term reference frame.

The present invention has been described in terms of specific embodiments incorporating details to facilitate the understanding of the principles of construction and operation of the invention. Such references, herein, to specific embodiments and details thereof are not intended to limit the scope of the claims appended hereto. It will be apparent to those skilled in the art that modifications can be made in the embodiments chosen for illustration without departing from the spirit and scope of the invention.

What is claimed is:

1. A method of encoding data including a plurality of successive frames, the method comprising:
a. receiving a plurality of input frames;
b. buffering a number of the plurality of input frames;
c. selecting one or more long term reference frames from the number of frames, wherein at least one of the one or more long term reference frames comprises a long term look-behind reference frame;
d. encoding the one or more long term reference frames, wherein encoding the at least one long term look-behind reference frame includes quantizing at an increased bit rate;
e. updating a prediction scheme according to the at least one long term look-behind reference frame; and
f. encoding a remainder of the number of frames according to the updated prediction scheme.

2. The method of claim 1 further comprising generating a quality index used to determine the increased bit rate.

3. The method of claim 2 further comprising updating the quality index each encoding cycle based on a comparison between the long term look-behind reference frame a reconstructed frame of the encoded long term look-behind reference frame.

4. The method of claim 1 further comprising managing a reference frame buffer to include a most current short term reference frames and a most current one or more long term reference frames.

5. The method of claim 4 further comprising encoding the short term reference frames and the remainder of the number of frames that are not short term reference frames according to an encoding scheme dictated by the standards.

6. The method of claim 5 wherein updating the prediction scheme comprises updating the reference frame buffer.

7. The method of claim 1 wherein encoding the remainder of the number of frames includes quantizing at a normal bit rate.

8. The method of claim 1 wherein encoding the one or more long term reference frames occurs in chronological order.

9. The method of claim 1 further comprising re-ordering the number of frames into an encoding frame sequence such that the one or more long term references are placed first in the encoding frame sequence.

10. The method of claim 1 wherein the prediction scheme includes correlation characteristics between the one or more long term reference frames and the number of frames.

11. The method of claim 10 further comprising determining the correlation characteristics by calculating a simple frame difference.

12. The method of claim 10 further comprising determining the correlation characteristics by utilizing a scene change detection method.

13. The method of claim 1 wherein the data is encoded according to an MPEG standard.

14. The method of claim 13 wherein the at least one long term look-behind reference frame comprises an I-frame.

15. The method of claim 14 further comprising selecting a next long term look-behind reference frame as a next I-frame in the plurality of input frames.

16. A method of encoding data, the method comprising:
a. receiving a plurality of input frames;
b. buffering a number of the plurality of input frames, wherein the number of frames includes at least a first I-frame, a second I-frame chronologically later than the first I-frame, and all frames therebetween;
c. selecting one or more long term reference frames from the number of frames, wherein at least one of the one or more long term reference frames comprises the second I-frame;
d. encoding the second I-frame;
e. updating a prediction scheme according to the encoded second I-frame; and
f. encoding a remainder of the number of frames according to the updated prediction scheme.

17. The method of claim 16 wherein the second I-frame comprises a long term look-behind reference frame.

18. The method of claim 17 wherein encoding the second I-frame includes quantizing at an increased bit rate.

19. The method of claim 18 wherein encoding the remainder of the number of frames includes quantizing at a normal bit rate, further wherein the increased bit rate is higher than the normal bit rate.

20. The method of claim 18 further comprising generating a quality index used to determine the increased bit rate.

21. The method of claim 20 further comprising updating the quality index each encoding cycle based on a comparison between the second I-frame and a reconstructed frame of the encoded second I-frame.

22. The method of claim 16 further comprising encoding the first I-frame and encoding the prediction scheme according to the encoded first I-frame prior to encoding the remainder of the number of frames.

23. The method of claim 22 wherein the first I-frame comprises a long term look-front reference frame.

24. The method of claim 16 further comprising managing a reference frame buffer to include a most current short term reference frames and a most current one or more long term reference frames.

25. The method of claim 24 further comprising encoding the short term reference frames and the remainder of the number of frames that are not short term reference frames according to an encoding scheme dictated by the standards.

26. The method of claim 25 wherein updating the prediction scheme comprises updating the reference frame buffer.

27. The method of claim 16 wherein encoding the one or more long term reference frames occurs in chronological order.

28. The method of claim 16 further comprising re-ordering the number of frames into an encoding frame sequence such that the one or more long term references are placed first in the encoding frame sequence.

29. The method of claim 16 wherein the prediction scheme includes correlation characteristics between the one or more long term reference frames and the number of frames.

30. The method of claim 29 further comprising determining the correlation characteristics by calculating a simple frame difference.

31. The method of claim 29 further comprising determining the correlation characteristics by utilizing a scene change detection method.

32. The method of claim 16 further comprising selecting a next long term look-behind reference frame as a next I-frame in the plurality of input frames.

33. The method of claim 16 wherein the data is encoded to substantially comply with a MPEG standard.

34. A system to encode data comprising:
a. an input buffer to receive a plurality of input frames and to buffer a number of the plurality of input frames;
b. a reference frame selection module coupled to the input buffer to select one or more long term reference frames from the number of frames, wherein one of the one or more long term reference frames comprises a long term look-behind reference frame;
c. a frame re-ordering module to sort the number of frames into an encoding frame sequence such that the one or more long term reference frames are first in the encoding frame sequence; and
d. an encoder to encode the number of frames according to the encoding frame sequence, wherein encoding the one or more long term look-behind reference frames includes quantizing at a first bit rate, and encoding a remaining portion of the number of frames includes using a prediction scheme formulated according to the encoded one or more long term look-behind reference frames and quantizing at a second bit rate, the first bit rate higher than the second bit rate.

35. The system of claim 33 further comprising a reference frame buffer to store a most current short term reference frames and a most current one or more long term reference frames.

36. The system of claim 34 further comprising a reference frame buffer management module to mange and update the reference frame buffer.

37. The system of claim 33 further comprising a quality index generator to generate a quality index used to regulate the first bit rate.

38. The system of claim 36 further comprising a quality index adaptor to compare a quality of a long term look-behind reference frame to an encoded long term look-behind reference frame to improve a corresponding quality index.

39. The system of claim 33 wherein the data is encoded to substantially comply with a MPEG standard.

40. The system of claim 38 wherein the at least one long term look-behind reference frame comprises an I-frame.

41. The system of claim 39 wherein the number of frames includes at least a first I-frame, a second I-frame chronologically later than the first I-frame, and all frames therebetween.
